(19) United States
(12) Patent Application Publication
(10) Pub. No.: US 2011/0102621 A1
(43) Pub. Date: May 5, 2011

(54) METHOD AND APPARATUS FOR GUIDING PHOTOGRAPHING

(75) Inventor: Won-jung Kim, Cheonan-si (KR)

(73) Assignee: Samsung Electronics Co., Ltd., Suwon-si (KR)

(21) Appl. No.: 12/915,232

(22) Filed: Oct. 29, 2010

(30) Foreign Application Priority Data
Oct. 30, 2009 (KR) 10-2009-0104310

(51) Int. Cl. H04N 5/228

(52) U.S. Cl. 348/222.1; 348/E05.031

(57) ABSTRACT

A digital image processing apparatus provides to a photographer and a subject reference images that are similar to a temporary image that is viewed through a view finder in terms of a background, a portrait, or an object, thereby enabling various photographings. The digital image processing apparatus includes a display unit on which an image is displayed, and a search unit that searches for the reference image, wherein the reference image and the temporary image are displayed on the display unit.

### CROSS-REFERENCE TO RELATED PATENT APPLICATION

This application claims the priority benefit of Korean Patent Application No. 10-2009-0104310, filed on Oct. 30, 2009, in the Korean Intellectual Property Office, the disclosure of which is incorporated herein in its entirety by reference.

### BACKGROUND

1. Field of the Invention

Embodiments relate to a digital image processing apparatus, and more particularly, to a method for guiding photographing in a digital image processing apparatus, and an apparatus for guiding photographing.

2. Description of the Related Art

Conventionally, images can be classified according to information about a subject photographed, for example, a shooting time or a shooting location. Images can also be classified according to a portrait or landscape shown in an obtained image. However, the classification is provided when a digital image processing apparatus is in a playback mode, that is, only after photographing is finished. Accordingly, the conventional image classification is not available during photographing.

### SUMMARY

Embodiments provide a reference image that is similar to a temporary image in terms of a background, a portrait, or an object.

According to an embodiment, a digital image processing apparatus includes: a display unit on which an image is displayed; and a search unit that searches for a reference image that is similar to a temporary image displayed on the display unit, wherein, when the reference image is not found, the search unit determines an image having a same regional or date information as the temporary image as the reference image, and the temporary image and the reference image are displayed on the display unit.

The reference image may be an image that is similar to the temporary image in terms of at least one selected from the group consisting of a background, a portrait, and an object.

The display unit may be divided into a plurality of areas on which the temporary image and the reference image are displayed together.

The digital image processing apparatus may include a plurality of display units, and the temporary image and the reference image are displayed on different display units.

According to another embodiment, a digital image processing apparatus includes: a display unit on which an image is displayed; and a search unit that searches for a reference image that is similar to a temporary image displayed on the display unit, wherein the reference image and the temporary image are displayed on the display unit.

The reference image is an image that has a same scene mode as the temporary image, among images stored in a memory, wherein the scene mode is selected from the group consisting of a night view portrait mode, a night view mode, a back light portrait mode, a portrait mode, a landscape mode, a macro mode, and an automatic exposure mode.

The temporary image may be an image that is seen through the viewfinder when a shutter button is half pressed.

The reference image may be an image that is similar to the temporary image in terms of at least one selected from the group consisting of a background, a portrait, and an object.

According to another embodiment, a method of guiding photographing in a digital image processing apparatus includes: searching for a reference image in a memory, wherein the reference image is an image similar to a temporary image displayed on a display unit; if the reference image is not found, determining an image having a same regional information as the temporary image as the reference image; if the image having the same regional information is not found, determining an image having a same date information as the temporary image as the reference images; and displaying the temporary image and the reference image.

The temporary image and the reference image may be displayed on a single display panel comprising a plurality of divided areas on which the temporary image and the reference image are displayed together.

The temporary image and the reference image may be displayed on a plurality of display panels.

### BRIEF DESCRIPTION OF THE DRAWINGS

The above and other features and advantages will become more apparent by describing in detail exemplary embodiments with reference to the attached drawings in which:

FIG. 1 is a perspective view of a digital image processing apparatus, according to an embodiment;

FIG. 2 is a rear view of the digital image processing apparatus of FIG. 1;

FIG. 3 is a block diagram of a digital camera as an example of a digital image processing apparatus, according to an embodiment;

FIGS. 4A and 4B illustrate examples of guiding photographing using a single display panel in a digital image processing apparatus;

FIG. 5 illustrates examples of guiding photographing using two display panels in a digital image processing apparatus;

FIG. 6 illustrates an example of guiding photographing;

FIG. 7A illustrates an example of self-photographing;

FIG. 7B illustrates an example of photographing with a remote controller; and

FIG. 8 is a flowchart illustrating a method of guiding photographing in a digital image processing apparatus, according to an embodiment.

### DETAILED DESCRIPTION

Hereinafter, embodiments will be described in detail with reference to the attached drawings.

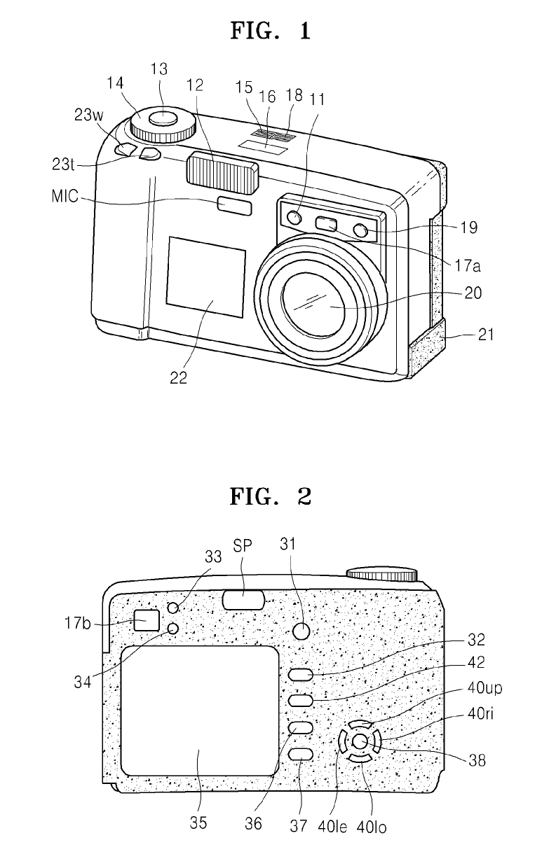

FIG. 1 is a perspective view of a digital image processing apparatus, according to an embodiment. FIG. 2 is a rear view of the digital image processing apparatus of FIG. 1

Referring to FIG. 1, the digital image processing apparatus according to the present embodiment includes two display panels. However, the embodiment illustrated in FIG. 1 should not be construed as limiting. For example, the digital image processing apparatus may include a single display panel or a rotational display panel.

The digital image processing apparatus includes a microphone MIC, a self-timer lamp 11, a flash 12, a shutter button 13, a function-selection dial 14, a shooting-information display unit 16, a view finder 17a, a function-blocking button 18, a flash-intensity sensor 19, a lens unit 20, an outer interface unit 21, a second display panel 22, a wide angle-zoom button 23w, and a telephoto-zoom button 23t.

When in a self-timer mode, the self-timer lamp 11 operates during a set time period from when the shutter button 13 is pushed to when a shutter begins to operate. The function-selection dial 14 is used when a user selects an operation mode of the digital image processing apparatus, such as a still image shooting mode, a night view shooting mode, a moving picture shooting mode, and a playback mode. The shooting-information display unit 16 displays information about the selected operation mode. The function-blocking button 18 is used when a user has selected an operation mode displayed by the shooting-information display unit 16.

A wide angle-zoom key 23w and a telephoto-zoom key 23t are disposed on a front surface of the digital image processing apparatus so as to control the second display panel 22 at a front side of the digital image processing apparatus. Referring to FIG. 2, direction keys including upwards shift key 40up, rightwards shift key 40ri, downwards shift key 40lo, and leftwards shift key 40le are disposed on a rear surface of the digital image processing apparatus on which a first display panel 35 is disposed, and thus the first display panel 22 is controlled using the direction keys 40up, 40ri, 40le, and 40lo. Each of the wide angle-zoom key 23w and the telephoto-zoom key 23t that are disposed on the front surface of the digital image processing apparatus may be used as a zoom button in a shooting mode, and may be also used as an image selection button in a playback mode.

In detail, in the shooting mode, when the wide angle-zoom key 23w is pushed, a subject to be photographed is zoomed out, and when the telephoto-zoom key 23t is pushed, a subject to be photographed is zoomed in. Meanwhile, in the playback mode, when the wide angle-zoom key 23w is pushed, a thumbnail image is displayed on the second display panel 22. In a case in which a desired image is reproduced, when the wide angle-zoom key 23w is pushed, a reduction view of the image is displayed, and when the telephoto-zoom key 23t is pushed, an enlarged view of the image is displayed.

The second display panel 22 is disposed next to the lens unit 20. In a self-shooting mode, self-photographing may be performed by referring to a preview image displayed on the second display panel 22.

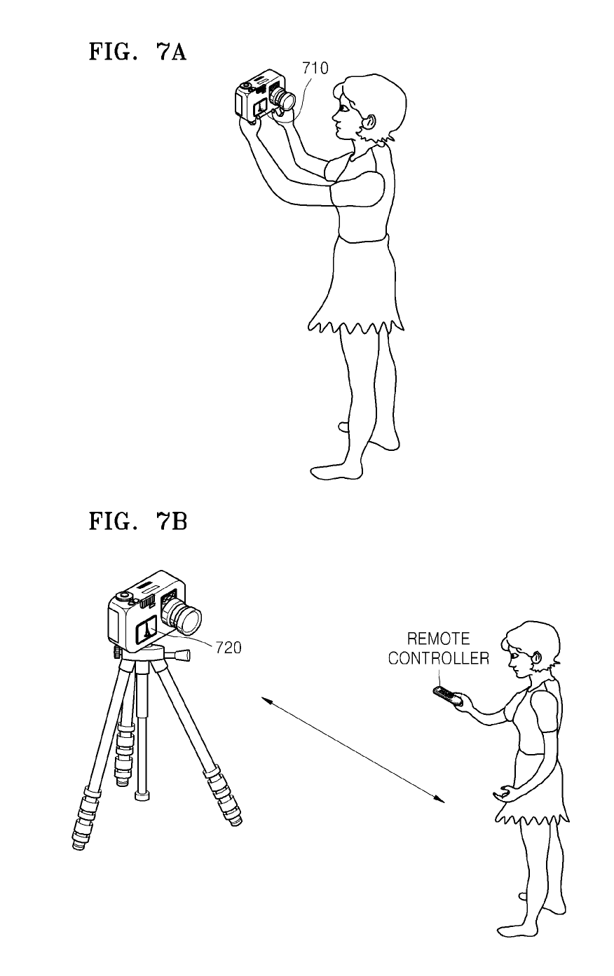

In a self-timer shooting mode (see FIG. 7A) or a remote controller-shooting mode (see FIG. 7B), count-down information may be displayed on the second display panel 22. In addition, when a landscape is photographed in the shooting mode, the second display panel 22 may display count-down information, or may be turned off.

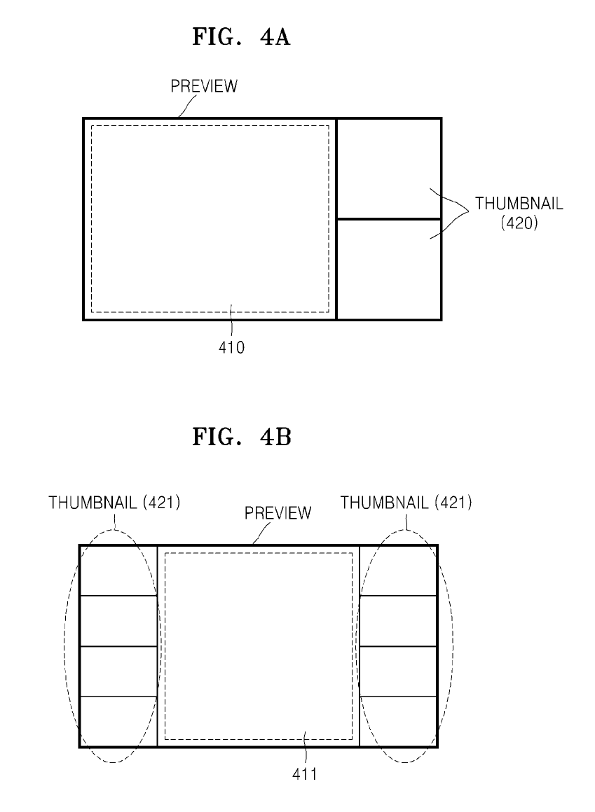

In order to share captured images with other people in the playback mode, a selected image or a thumbnail image of the captured images may be displayed on the second display panel 22. In addition, during photographing, an image that is similar to a subject to be photographed in terms of, for example, a portrait, a landscape, or an object may be selected from images stored in a memory and then displayed to a photographer. Thus, the photographer may take various pictures by referring to the image. This process will be described in detail later with reference to FIG. 4.

Referring again to FIG. 2, the digital image processing apparatus includes, on its rear side, a speaker SP, a power source button 31, a monitor button 32, an automatic-focus lamp 33, a view finder 17b, a flash stand-by lamp 34, the first display panel 35, an exposure correction/deletion button 36, an enter/reproduction button 37, a menu/OK button 38, the upwards shift button 40up, the rightwards shift button 40ri, the downwards shift button 40lo, the leftwards shift button 40le, and a playback button 42.

The monitor button 32 allows a user to control the first and/or second display panels 35 and 22. For example, if a user pushes the monitor button 32 once, an image of a subject and related shooting information are displayed on the first and/or second display panels 35 and 22. If a user pushes the monitor button 32 twice, only the image of a subject is displayed on the first and/or second display panels 35 and 22. If a user pushes the monitor button 32 three times, the first and/or second display panels 35 and 22 are turned off.

The automatic-focus lamp 33 operates when automatic focusing is completely performed.

The flash stand-by lamp 34 operates when a flash 12 is ready to operate.

The exposure correction/deletion button 36 may be used to control intensity of light when a user controls the digital image processing apparatus, or may also be used as a deletion button whenever a user sets an operation mode.

The enter/reproduction button 37 may allow a user to input data, or may be used to stop or reproduce a due operation in the playback mode.

The menu/OK button 38 may be used to display or select a menu of a mode that has been selected using the function-selection dial 14.

The upwards shift button 40up, the rightwards shift button 40ri, the downwards shift button 40lo, and the leftwards shift button 40le allow a user to select an operation mode.

The playback button 42 may be used to identify and manipulate an image that is most recently captured, or a moving picture or voice information thereof.

The first display panel 35 is turned off in a self shooting mode. In the shooting mode, however, the first display panel 35 is turned on and provides a preview image. In the playback mode, a selected image or a thumbnail image of captured images may be displayed on the first display panel 35 in order to share the captured images with other people.

Like the second display panel 22, the first display panel 35 may also display to a photographer an image that is similar to a subject to be photographed in terms of, for example, a portrait, a landscape, or an object and that is selected from images stored in a memory, so that the photographer may take various pictures by referring to the image. This process will be described in detail later with reference to FIG. 4.

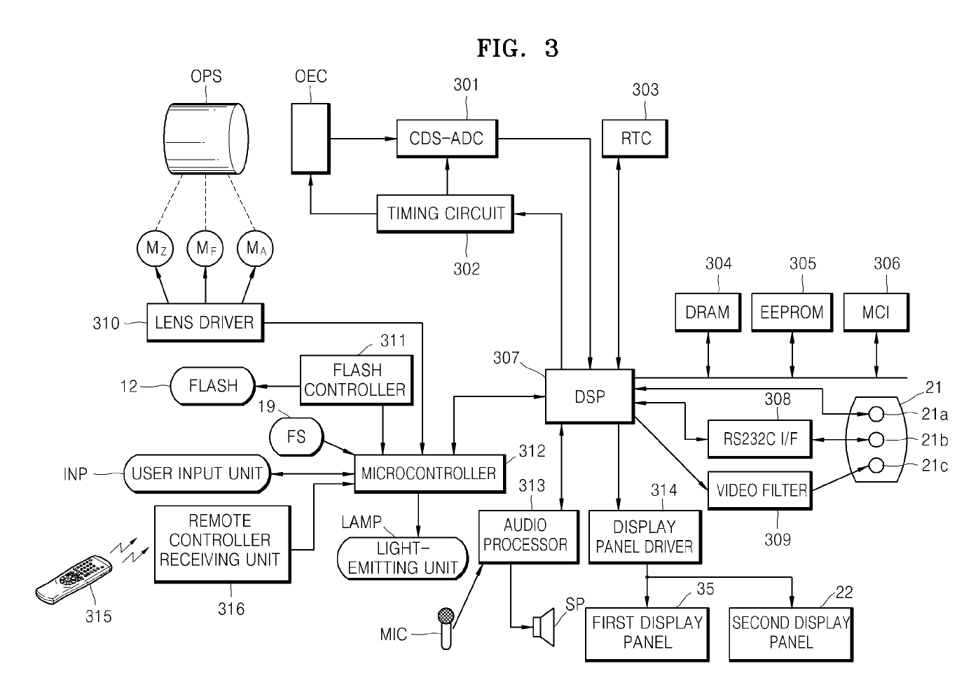

FIG. 3 is a block diagram of a digital camera as an example of a digital image processing apparatus, according to an embodiment. Although the digital camera illustrated in FIG. 3 includes two display panels, according to other embodiments, the digital camera may also include a single display panel or three or more display panels.

An optical system OPS processes light from a subject. The optical system OPS may include a zoom lens (ZL, not shown), a focus lens (FL, not shown), and a compensation lens (CL, not shown).

When a user pushes the wide angle-zoom button 23w (see FIG. 1) or the telephoto-zoom button 23t (see FIG. 1), which are included in a user input unit INP, a corresponding signal is input to a microcontroller 312. Thus, the microcontroller 312 controls a lens driver 310 and a zoom motor M_{Z} is driven and thus, the zoom lens ZL is moved.

Thus, the microcontroller 312 may calculate an angle θ with respect to location of the zoom lens ZL by using data of the optical system OPS. In this regard, the angle θ is hardly affected by location of the focus lens FL because the location of the focus lens FL is adjusted only after location of the zoom lens ZL is set. The microcontroller 312 controls the lens driver 310 to drive a focus motor M_{F} and thus, the focus lens FL is moved. The compensation lens CL is not separately driven because the compensation lens CL compensates for a refraction rate of the digital image processing apparatus.

The digital image processing apparatus also includes a motor for driving an aperture M_{A}. The motor M_{A} may have different rotational angles according to whether the digital image processing apparatus is in a designated exposure mode. In the designated exposure mode, when a desired region in a subject region matches a designated detection region displayed on the first and/or second display panels 22 and 35, the amount of exposure of the digital image processing apparatus is set with respect to an average brightness of the designated detection region.

The optical system OPS may include an optical low pass filter (OLPF, not shown) and an infrared cut filter (IRF, not shown). The optical low pass filter (OLPF) removes optical noise having high frequency, and the infrared cut filter (IRF) cuts an infrared component of incident light.

An optical-to-electrical converter OEC, such as a charge coupled device (CCD) or a complementary metal-oxide-semiconductor (CMOS), converts light transferred by the optical system OPS into an analog electrical signal. In this regard, a digital signal processor (DSP) 307 controls operations of the optical-to-electrical converter OEC and a correlation double sampler and analog-to-digital converter (CDS-ADC) 301, which is an analog-digital converter, by controlling a timing circuit 302.

The CDS-ADC 301 may process an analog signal transmitted by the optical-to-electrical converter OEC in order to remove high-frequency noise and adjust amplitude, and then may convert the processed analog signal into a digital signal. The DSP 307 processes a digital signal transmitted by the CDS-ADC 301 and generates a digital image signal that includes a brightness signal and a chromaticity signal.

A light-emitting unit LAMP that is driven by the microcontroller 312 includes the self-timer lamp 11 (see FIG. 1), the automatic-focus lamp 33 (see FIG. 2), and the flash stand-by lamp 34 (see FIG. 2). The user input unit INP includes the shutter button 13 (see FIG. 1), the function-selection dial 15 (see FIG. 1), the function-blocking button 18 (see FIG. 1), the monitor button 32 (see FIG. 2), the exposure correction/deletion button 36 (see FIG. 2), the enter/reproduction button 37 (see FIG. 2), the menu button 38 (see FIG. 2), the wide angle-zoom button 23w (see FIG. 1), the telephoto-zoom button 23t (see FIG. 1), the upwards shift button 40up (see FIG. 2), the rightwards shift button 40ri (see FIG. 2), the downwards shift button 40lo (see FIG. 2), and the leftwards shift button 40le (see FIG. 2).

A dynamic random access memory (DRAM) 304 temporarily stores digital image signals transmitted by the DSP 307.

An electrically erasable programmable read only memory (EEPROM) 305 may store a program for driving the DSP 307 and set data.

A memory card interface (MCI) 306 receives a memory card of a user.

A real time clock (RTC) 303 may be coupled with the DSP 307 to determine a current time and/or date.

A digital image signal transmitted by the DSP 307 is input to a display panel driver 314, and the display panel driver 314 displays a corresponding image on the first and/or second display panels 35 and 22.

The DSP 307 detects a face in the image. When a face is detected, it is determined whether a live view image is a night view mode, and then if not, a back light mode, and then if not, a portrait mode. When a face is not detected, it is determined whether a live view image is a night view mode, and then if not, a landscape mode, and then if not, a macro mode, and then if not, an automatic exposure mode.

In order to efficiently recognize an image, the DSP 307 may automatically classify an input image as a night view portrait mode, a night view mode, a back light portrait mode, a portrait mode, a landscape mode, a macro mode, or a default automatic exposure mode, which are examples of a scene mode. In addition, the input image may also be classified as other scene modes.

Meanwhile, a digital image signal transmitted by the DSP 307 may be transmitted in a serial communications manner through a universal serial bus (USB) connection unit 21a, or an RS232C interface 308 and a connection unit thereof 21b, and may be transmitted as a video signal through a video filter 309 and a video output unit 21c.

An audio processor 313 outputs a voice signal transmitted by the microphone MIC to the DSP 307 or a speaker SP, and outputs an audio signal transmitted by the DSP 307 to the speaker SP. Meanwhile, the flash 12 is driven by the microcontroller 312 and a flash controller 311 in correspondence to a signal transmitted by the flash-intensity sensor (FS) 19.

The DSP 307 controls operation of the display panel driver 314 in such way that the first display panel 35 and/or the second display panel 22 displays a corresponding image or information according to an operation mode, such as the shooting mode or the playback mode.

In the shooting mode, optionally, the first display panel 35 displays a preview image during photographing and the second display panel 22 displays a still image captured, wherein the preview image and the still image are simultaneously displayed. Thus, the captured image may be identified immediately after photographing without a specific manipulation.

In the self-shooting mode, the DSP 307 turns off the first display panel 35, and turns on the second display panel 22. The user may take his or her own picture while viewing an image of the user being displayed on the second display panel 22. In addition, the user may determine his or her pose or facial expression to be photographed after viewing similar images displayed in a thumbnail form on the second display panel 22. This process will be described in detail later with reference to FIG. 4.

If self-photographing is performed with or without a remote controller 315 when the user is located away from a digital camera fixed to a tripod, when the user inputs shooting information by using the remote controller 315, a remote controller receiving unit 316 receives the shooting information. The microcontroller 312 analyzes the shooting information received by the remote controller receiving unit 316 and controls operation of the DSP 307 according to analysis results of the shooting information.

In the shooting mode, the DSP 307 turns on the first display panel 35 and turns on or off the second display panel 22. In this regard, if a subject to be photographed is located close to the digital image processing apparatus, the DSP 307 turns on the second display panel 22. Thus, the subject may view his or her image to be captured displayed on the second display panel 22 within a predetermined distance and thus, a more natural image may be obtained. In addition, by displaying similar reference images that have been captured on the second display panel 22 as a thumbnail form, various images may be obtained.

FIGS. 4 through 8 are views to explain a photographing guide mode, according to an embodiment.

The photographing guide mode refers to a mode in which a temporary image of a subject viewed through a view finder in the shooting mode and reference images that are images similar to the temporary image are simultaneously displayed in a thumbnail form. The temporary image may also be, in addition to the image of a subject viewed through a view finder, an image that is continuously displayed on a screen when a digital image processing apparatus such as a camera is turned on.

In the photographing guide mode, a photographer or a subject to be photographed may refer to reference images. For example, if there are many similar background images, other background images may be captured. In addition, if there are many similar facial expression or pose images, the photographer may also ask the subject to be photographed to change his or her facial expression or pose. The subject to be photographed may also view the reference images and changes his or her facial expression.

In various embodiments, the reference images are images that have similar information as the temporary image, for example, an image that has the same regional information as the temporary image, or an image that has the same date information as the temporary image. However, the definition of the reference image may vary as long the definition is understood by one of ordinary skilled in the art.

For example, the reference image may also be an image that has the same pose or background composition as the temporary image.

In addition, the reference images may also be images that are categorized as the same scene mode among images that are stored in a memory. For example, if the temporary image is set in a back light portrait mode, the reference images may also be back light portrait mode images. That is, a scene mode of the temporary image is determined based on an image that is continuously displayed on a screen when a camera is turned on, and then an image having the same scene mode is set as a reference image. The scene mode may be a night view portrait mode, a night view mode, a back light portrait mode, a portrait mode, a landscape mode, a macro mode, an automatic exposure mode, or the like.

In addition, images stored in a memory may be chronologically or reverse-chronologically ordered and then, some or all of the images may be displayed as the reference image. For example, recently captured images are reverse-chronologically ordered so that the most recently captured image comes first, and then four or eight images may be displayed as the reference image according to settings of a display.

According to another embodiment, images having the same scene mode may be chronologically ordered. For example, images are classified into images having the same night view portrait mode, images having the same night view mode, images having the same back light portrait mode, images having the same portrait mode, images having the same landscape mode, images having the same macro mode, and images having the same automatic exposure mode, and then images belonging to the same scene mode group may be chronologically displayed as the reference image. In addition, other image classification methods or other ordering methods may also be used.

FIGS. 4A and 4B illustrate examples of guiding photographing using a single display panel in a digital image processing apparatus.

The present embodiment may be applied to a case in which the second display panel 22 illustrated in FIG. 1 is not included in a digital image processing apparatus. However, the invention is not limited thereto, and any embodiment that is realized by one of ordinary skill in the art may be included in the invention.

Referring to FIGS. 4A and 4B, the single display panel of a digital image processing apparatus, for example, the first display panel 35 of FIG. 2, may be divided into one or more portions.

According to an embodiment, a temporary image 410 or 411, which is obtained when the shutter button 13 (see FIG. 1) is partially pushed, is displayed as a preview. Then, the temporary image 410 or 411 is analyzed and then a reference image similar to the temporary image is displayed as a thumbnail 420 or 421 together with the temporary image.

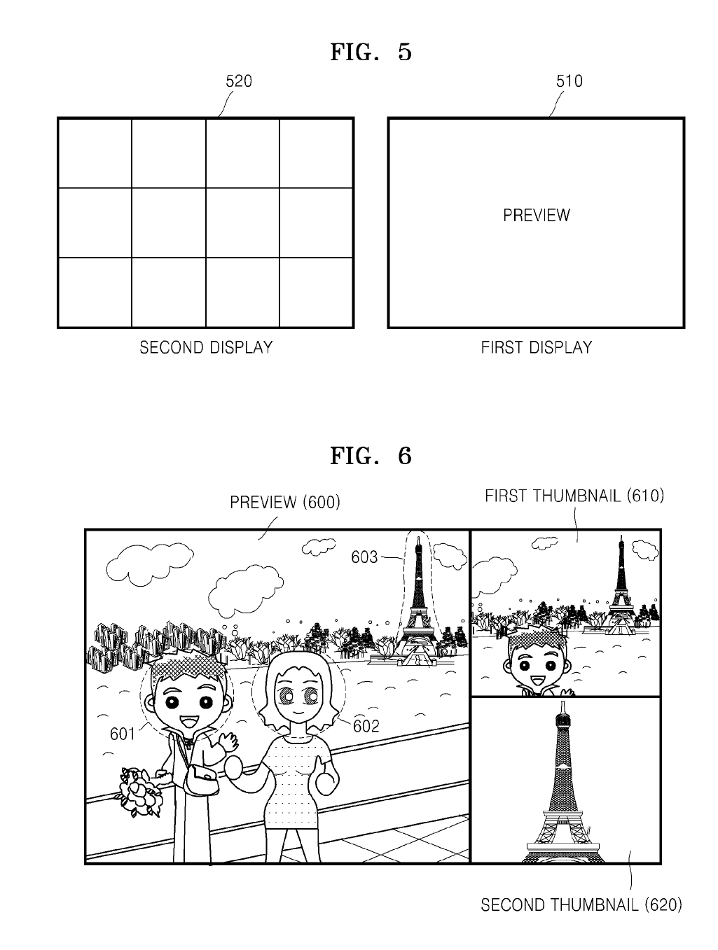

According to another embodiment, in a digital image processing apparatus using a single display panel, a switch mode may be used to switch the preview with a reference image thumbnail list that is displayed on an entire screen of, for example, a second display 520 of FIG. 5.

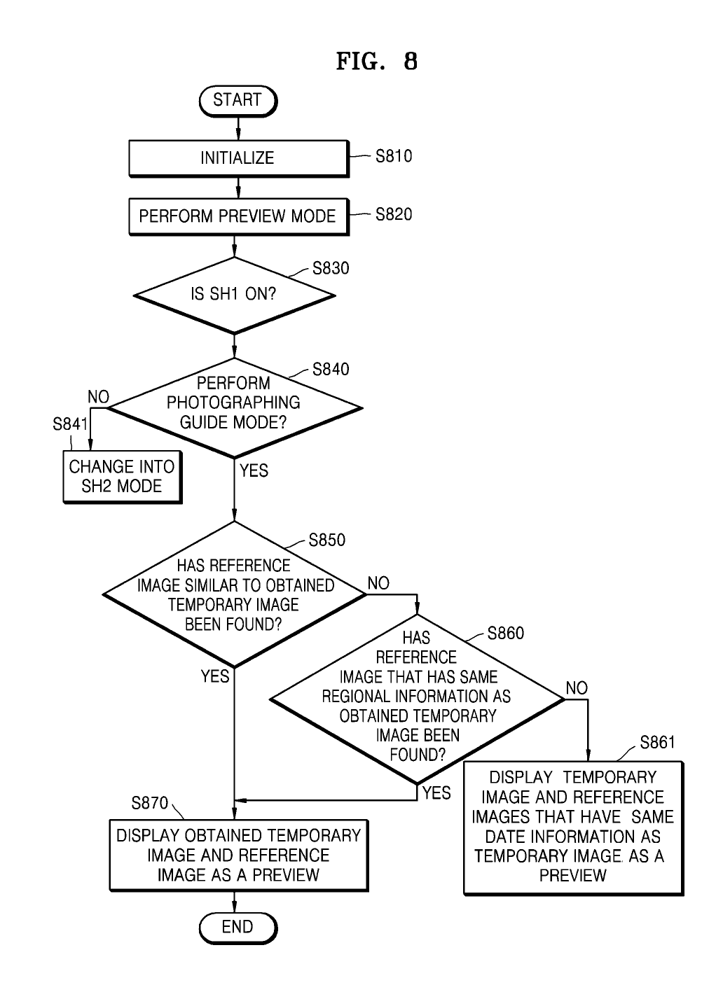

In addition, when the switch mode is selected again, the preview is displayed like a first display 510 of FIG. 5. The reference image is searched for among images that have been stored in the digital image processing apparatus. A method of searching for reference images will be described in detail later with reference to FIG. 8.

In the preview mode, the DSP 307 (see FIG. 3) may turn on the first and second display panels 35 and 22. In this regard, the DSP 307 may control the first and second display panels 35 and 22 so that according to user selection, the same image may be displayed on the first and second display panels 35 and 22. Alternatively, 4, 6, 9, or 16 images may be displayed on either one of the first and second display panels 35 and 22 while the other one of the first and second display panels 35 and 22 displays a selected image on its entire screen.

In addition, the first display panel 35 may display the first display 510 to preview a temporary image of a subject viewed through a view finder, and the second display panel 22 may display the second display 520 to display reference images that are similar to the previewed temporary image. According to another embodiment, each of the first and second displays 510 and 520 may be divided in the same manner as illustrated in FIGS. 4A and 4B.

FIG. 6 illustrates an example of guiding photographing.

When a preview image 600 is obtained by partially pushing a shutter button, the DSP 307 (see FIG. 3) operates in such a way that among images stored in a digital image processing apparatus, images that are similar to the image 600 are displayed as first and second thumbnails 610 and 620.

If the image 600 is a portrait image, an image that has a region similar to at least one of face regions 601 and 602 is searched from among all the images stored in a digital image processing apparatus. If an image that has a region similar to the face region 601 is found, the image is displayed as the first thumbnail 610.

In addition, in order to search for a reference image, the DSP 307 (see FIG. 3) may refer to, in addition to the face regions 601 and 602, a background 603 of the image 600. For example, an image that is similar to the background 603 of the image 600 may be displayed as the second thumbnail 620. Although FIG. 6 illustrates one first thumbnail 610 and one second thumbnail 620, the number of first thumbnails and the number of second thumbnails may be changed. In addition, first and second thumbnails may also be displayed in various manners.

In addition, according to whether the image 600 is a portrait image or a background image, a search criterion that is used to search for similar images may be changed.

FIG. 7A illustrates an example of self-photographing, and FIG. 7B illustrates an example of photographing using a remote controller. The self-photographing and the photographing using a remote controller may also be performed as described above.

In detail, FIG. 7A illustrates an example of self-photographing using a digital image processing apparatus including two display panels. In this regard, if a user selects a photographing guide mode, the first display panel 35 (see FIG. 2) may display a temporary image (see first display 510 of FIG. 5) of a subject previewed through a view finder, and a second display panel 710 may display as a thumbnail (see second display 520 of FIG. 5) the reference image similar to the temporary image previewed on the first display panel 35. A subject to be photographed may pose variously or select different backgrounds by referring to the thumbnail displayed on the second display panel 710 (see second display 520 of FIG. 5). The second display panel 710 may include an embodiment of the second display panel 22 of FIG. 1.

Referring to FIG. 7B, when photographing is performed using a remote controller (e.g., remote controller 315 of FIG. 3), a subject to be photographed may pose variously by referring to a thumbnail displayed on a second display panel 720 (see second display 520 of FIG. 5). The second display panel 720 may include an embodiment of the second display panel 22 of FIG. 1. In addition, if the digital image processing apparatus includes a single display panel, a subject to be photographed may pose variously by referring to a thumbnail displayed on the first display panel 35 (see first display 510 of FIG. 5).

FIG. 8 is a flowchart illustrating a method of guiding photographing in a digital image processing apparatus, according to an embodiment.

The method according to the present embodiment includes initializing the digital image processing apparatus (operation S810) and operating a preview mode (operation S820). After it is identified whether a shutter button is partially pushed (SH1 is on) (operation S830), it is determined whether to operate a photographing guide mode (operation S840). If the photographing guide mode does not operate, a mode is changed into SH2 mode, where the shutter button may be completely pressed (operation S841). If the photographing guide mode operates, it is determined whether a reference image which is similar to a temporary image obtained when the shutter button is partially pushed is found after searching in a memory (operation S850). If the reference image is not found, it is determined whether a reference image that has the same regional information as the temporary image has been found (operation S860). If the reference image that has the same regional information as the temporary image is not found, the temporary image and reference images that have the same date information as the temporary image are displayed (operation S861). If a reference image similar to the temporary image (operation S850) or that has the same regional information as the temporary image (operation S860) is found, the temporary image and the reference image is displayed on a display unit (operation S870).

Hereinafter, the method will be described in detail.

If a shutter button is half pressed (SH1 is on) (operation S830), a photographer may select a photographing guide mode (operation S840). If the photographing guide mode is not selected, the photographer may directly perform photographing (SH2 is on) (operation S841). The photographing guide mode may be performed as follows.

First, reference images are searched for in a memory when the shutter button is half pressed. The reference images are similar to a temporary image obtained when the shutter button is half pressed (SH1 is on). For example, reference images are searched in the memory based on the scene types such as a portrait image or a scenic mode.

If the temporary image is a portrait image, an image having a face region similar to the temporary image may be searched for based on facial unchanged features, such as eyes, a nose, or a mouth, or facial characteristics such as a skin texture or a skin color.

In addition, a facial template-based detection method may also be used. According to the facial template-based detection method, several standard facial templates are set and then stored for face detection. Then, the facial templates are each compared with an image in an image search window in order to search for similar face images.

The face detection may be achieved using a support vector machine (SVM). According to the SVM-based method, different regions of an image are sub-sampled and then the SVM is learned to differentiate a facial region from a non-facial region, that is, a region that does not belong to a face, and then, the SVM searches for a face in an input image. However, the face detection method is not limited thereto and any face detection method that is understood by one of ordinary skill in the art may also be used.

If the reference image is not found in operation S850, an image that has the same regional information as the temporary image is set as the reference image (operation S860). The regional information of the temporary image may be obtained using a global positioning system (GPS) of the digital image processing apparatus. In addition, as for images stored in a memory, since the latitude and longitude of a shooting place calculated using the GPS is used as Exif information of an image, an image having the same regional information as the temporary image may be found and used as a reference image.

If an image having the same regional information as the temporary image is not found in operation S860, images that have the same date information as the temporary image are determined as the reference images and previewed together with the temporary image on a display unit (operation S861). Since images stored in a memory of a digital image processing apparatus contain shooting time information, an image that has the same date information as the temporary image may be found and used as a reference image.

The reference image obtained in operation S850 or operation S860 is previewed together with the temporary image on a display unit (operation S870). The reference image and the temporary image may be variously displayed as described with the embodiments illustrated in FIGS. 4A, 4B, and 5.

For example, if a single display panel is used, the temporary image and the reference images may be displayed together on divided areas of the single display panel, or the temporary image and the reference images may be sequentially displayed on the same display panel. If two or more display panels are used, the temporary image and the reference images may be displayed on different display panels or may be displayed together on the same display panel.

The digital image processing apparatus described herein may comprise a processor, a memory for storing program data to be executed by the processor, a permanent storage such as a disk drive, a communications port for handling communications with external devices, and user interface devices, including a display, keys, etc. When software modules are involved, these software modules may be stored as program instructions or computer readable code executable by the processor on a non-transitory computer-readable media such as read-only memory (ROM), random-access memory (RAM), CD-ROMs, magnetic tapes, floppy disks, and optical data storage devices. The computer readable recording media may also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. The words “mechanism” and “element” are used broadly and are not limited to mechanical or physical embodiments, but may include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. It will be recognized that the terms “comprising,” “including,” and “having,” as used herein, are specifically intended to be read as open-ended terms of art.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention.

What is claimed is:

1. A digital image processing apparatus comprising:
a display unit on which an image is displayed; and
a search unit that searches for a reference image that is similar to a temporary image displayed on the display unit,
wherein when the reference image is not found, the search unit determines an image having a same regional or date information as the temporary image as the reference image, and
the temporary image and the reference image are displayed on the display unit.

2. The digital image processing apparatus of claim 1, wherein the reference image is an image that is similar to the temporary image in terms of at least one selected from the group consisting of a background, a portrait, and an object.

3. The digital image processing apparatus of claim 1, wherein the display unit is divided into a plurality of areas on which the temporary image and the reference image are displayed together.

4. The digital image processing apparatus of claim 1, wherein the digital image processing apparatus comprises a plurality of display units, and the temporary image and the reference image are displayed on different display units.

5. A digital image processing apparatus comprising:
a display unit on which an image is displayed; and
a search unit that searches for a reference image that is similar to a temporary image displayed on the display unit,
wherein the reference image and the temporary image are displayed on the display unit.

6. The digital image processing apparatus of claim 5, wherein the reference image is an image that has a same scene mode as the temporary image, among images stored in a memory, wherein the scene mode is selected from the group consisting of a night view portrait mode, a night view mode, a back light portrait mode, a portrait mode, a landscape mode, a macro mode, and an automatic exposure mode.

7. The digital image processing apparatus of claim 5, wherein the reference image is an image that is similar to the temporary image in terms of at least one selected from the group consisting of a background, a portrait, and an object.

8. The digital image processing apparatus of claim 5, wherein the reference image is selected from images that are reverse-chronologically ordered so that the most recently captured image is selected first.

9. The digital image processing apparatus of claim 5, wherein when the reference image is not found, the search unit determines an image having a same regional information as the temporary image as the reference image and the determined image is displayed on the display unit.

10. The digital image processing apparatus of claim 5, wherein when the reference image is not found, the search unit determines an image having a same date information as the temporary image as the reference images and the determined image is displayed on the display unit.

11. The digital image processing apparatus of claim 5, wherein the display unit is divided into a plurality of areas on which the temporary image and the reference image are displayed together.

12. The digital image processing apparatus of claim 5, wherein the digital image processing apparatus comprises a plurality of display units, and the temporary image and the reference image are displayed on different display units.

13. The digital image processing apparatus of claim 5, wherein the temporary image is an image that is displayed on the display unit when a shutter button is half pressed.

14. A method of guiding photographing in a digital image processing apparatus, the method comprising:
searching for a reference image in a memory, wherein the reference image is an image similar to a temporary image displayed on a display unit;
if the reference image is not found, determining an image having a same regional information as the temporary image as the reference image;
if the image having the same regional information is not found, determining an image having a same date information as the temporary image as the reference image; and
displaying the temporary image and the reference image.

15. The method of claim 14, wherein the temporary image and the reference image are displayed on a single display panel comprising a plurality of divided areas on which the temporary image and the reference image are displayed together.

16. The method of claim 14, wherein the temporary image and the reference image are displayed on a plurality of display panels.
